(19) United States
(12) Patent Application Publication
(10) Pub. No.: US 2012/0005607 A1
(43) Pub. Date: Jan. 5, 2012

(54) FLOATING WINDOW

(75) Inventors: Michael N. Tofinetti, Kanata (CA); Katha Kulasingam, Kanata (CA); David Kiesekamp, Merrickville (CA)

(73) Assignee: ALCATEL-LUCENT CANADA INC., Kanata (CA)

(21) Appl. No.: 12/827,129

(22) Filed: Jun. 30, 2010

(51) Int. Cl. G06F 3/048

(52) U.S. Cl. 715/769; 715/777; 715/781; 715/810

(57) ABSTRACT

A method is provided for creating a floating window in a perspective view of data, such as network management data. The floating window can be moved freely about the perspective and resized, thereby allowing other data of importance which is tied to areas of the perspective to be seen. Portlets, containing aspects of data, can be located in the floating window. The floating window in modal mode is particularly useful for requiring a user to interact with or view data without being able to interact with data in the rest of the perspective. The floating window can also be created in non-modal mode, which allows a user to move portlets from existing areas to the more flexible floating window.

### FIELD OF THE INVENTION

This invention relates to graphical user interfaces, and more particularly to a method of displaying multiple pieces of information.

### BACKGROUND OF THE INVENTION

Management of customer information in telecommunication networks often requires the presentation of many pieces of information. For example, information related to billing rates and expected levels of service must be presented to an administrator so that the administrator can obtain current information or can edit information stored in a database. The information may be presented as lines of text, but a graphical user interface allows an administrator to select various items, to more easily view the current state of the selected items, and to more easily change the information related to the selected items.

The flexibility given to the administrator may come at a cost, however. As the administrator selects different views of the information, different aspects of the information presented to the administrator in different windows may become difficult to manage, especially when the administrator starts moving the windows around. For example, the administrator may wish to view information concerning a particular subscriber in a telecommunication network. A Listing window is used to find existing subscribers or to create new ones. Individual subscribers are created or edited in forms specific to the subscriber data. These forms contain many fields, such as category, user identifier, description, a list of subscription identifiers, custom data, and a list of called station identifiers. Each of these called station identifiers contains a large amount of information dealing with Quality of Service (QoS) parameters: defaults, aggregate maximum bit rates, guaranteed bit rates, maximum bit rates for QoS classes, associated AF applications, and custom data. Many of these are lists which open up configuration forms of their own. In addition, there is a separate search facility to find a subscriber by a specific subscription identifier. This is a search window which opens on top of the subscriber list.

U.S. patent application Ser. No. 12/707,865, entitled “Perspective View”, filed on Feb. 18, 2010, and incorporated herein by reference, provides a solution to presenting many pieces of data. Information is presented in portlets organized within areas such that different portlets can be selected easily. The areas form a perspective, such that different areas, and hence different portlets, can be viewed simultaneously.

Each portlet belongs to an area. Each area specifies which types of portlet can exist in the area, and each portlet can potentially be dragged to another area. However, when an attempt is made to drag a portlet to an area, the types of portlet supported by that area are checked. If the type of portlet being dragged is not listed amongst the types of portlet supported by the area, then the attempt to place the portlet in the area fails and the portlet remains in the area from which it was dragged. It may nevertheless be desirable to have a portlet exist independently of an existing area.

### SUMMARY OF THE INVENTION

According to one aspect, the invention provides a method of displaying a graphical user interface. A perspective is displayed, and at least one area is displayed within the perspective. Within each area, at least one portlet tab is displayed, each such portlet tab being associated with one portlet. Within each area, the portlet associated with a selected one of the at least one portlet tab within the area is displayed. A floating window is displayed so as to overlay portions of at least one of the areas, the floating window containing at least one portlet and being freely movable about the perspective.

According to another aspect, the invention provides a method of displaying a graphical user interface. A perspective is displayed, and at least one area is displayed within the perspective. Within each area, at least one portlet tab is displayed, each such portlet tab being associated with one portlet. Within each area, the portlet associated with a selected one of the at least one portlet tab within the area is displayed. A context menu is displayed for a portlet which is visible, the context menu including a selectable item to undock the portlet. A floating window is displayed so as to overlay portions of at least one of the areas upon selection of the item to undock the portlet, removing the portlet from its area, and displaying the portlet in the floating window.

According to another aspect, the invention provides a method of displaying a graphical user interface. A perspective is displayed, and at least one area is displayed within the perspective. Within each area, at least one portlet tab is displayed, each such portlet tab being associated with one portlet. Within each area, the portlet associated with a selected one of the at least one portlet tab within the area is displayed. When an application-specific request for data is required, a floating window is displayed so as to overlay portions of at least one of the areas, the floating window containing a portlet displaying the data and being freely movable about the perspective.

The methods of the invention may be stored as processing instructions on computer-readable storage media, the instructions being executable by a computer processor.

The invention allows one or more portlets of a perspective to exist within a floating window. The floating window can be created by the user expressly undocking an existing portlet. In this case the floating window is in a non-modal mode, and the user can drag the initial and other portlets to and from the floating window. The floating window can also be created by an application-specific request for data, in which case the floating window is created with a portlet displaying the application-requested data. In this case the floating window is in a modal mode, and the user cannot interact with other parts of the perspective while the floating window is open. In either case, the floating window is tied to the perspective but not to one of the areas. The floating window is displayed as overlaying the areas of the perspective, and be moved freely about the perspective.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of an example perspective;

FIG. 2 is a diagram of an example area according to one embodiment of the invention; and

FIG. 3 is a diagram of an example perspective containing a floating window according to one embodiment of the invention.

It is noted that in the attached figures, like features bear similar labels.

### DETAILED DESCRIPTION OF THE PREFERRED EMBODIMENTS

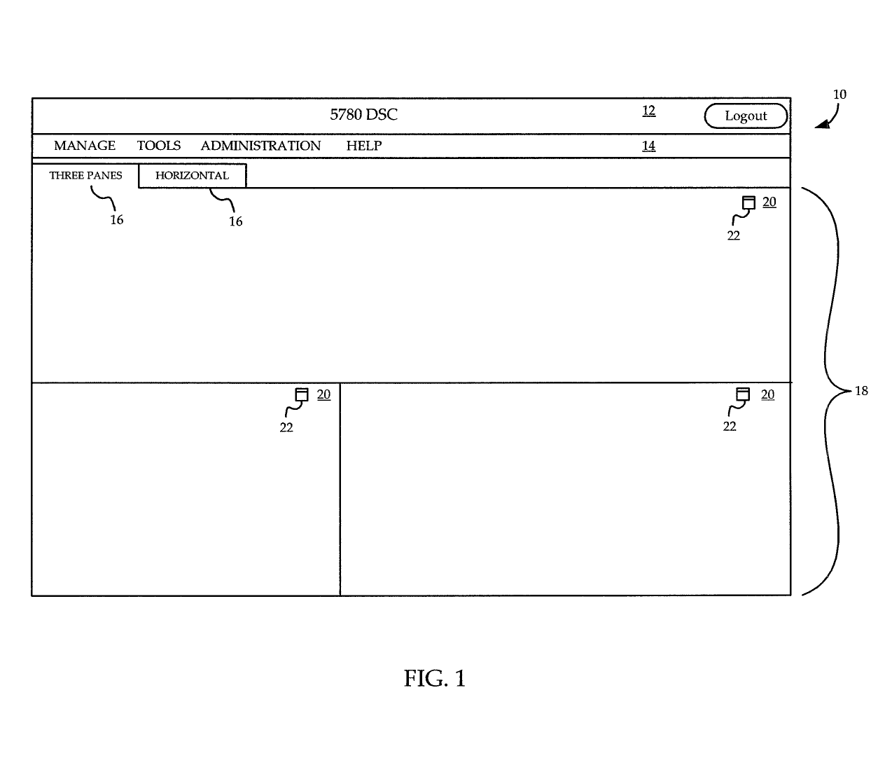

Referring to FIG. 1, a diagram of an example perspective is shown. At the top level a user is presented with an application interface 10. Preferably, the application interface 10 occupies the entire display area of a display device. The application interface 10 includes a title bar 12, a menu bar 14, one or more tabs 16 called “perspective tabs”, and one or more stacked views called “perspectives” 18. Each perspective tab 16 has an associated perspective 18, and selecting one of the perspective tabs makes the perspective 18 associated with that perspective tab visible. Each perspective is an overall view of some aspect of information. Only one perspective is displayed, but if more than one perspective is available then the user can select a particular perspective to be displayed using the perspective tabs. In the example shown in FIG. 1, the user can select between two perspectives. The available perspectives may be either predefined or may be generated by the user. Generation of a perspective by a user provides flexibility in what data the user sees or interacts with.

Each perspective contains at least one pane, termed an “area”. In the example shown in FIG. 1, the perspective 18 contains three areas 20. Within a displayed perspective 18, the areas 20 may be resized but in general may not be created or destroyed. In other words, the number of areas within each perspective is normally_fixed, but more generally a user may create one or more areas within a perspective. The definition of each area includes the types of portlet (described below) permitted in the area, in other words the types of portlet that can exist or be created within the area. Each area has two list definitions for this purpose, one of which lists the types of portlets which can be created within the area and one of which lists the types of portlets which can exist within the area. Either list may indicate that all portlet types can be created or are allowed, either by explicitly listing all the portlet types or by listing a special value. For example, the list of types of portlets which can exist within an area may be empty, which indicates that all types of portlets can exist within the area. Examples of types of portlets are Lists, Forms, and Trees.

Each area also has a maximize icon 22 for maximizing the area to occupy the entire perspective view, at which point a normalize icon (not shown in FIG. 1) becomes visible or selectable for restoring the area to its normal size.

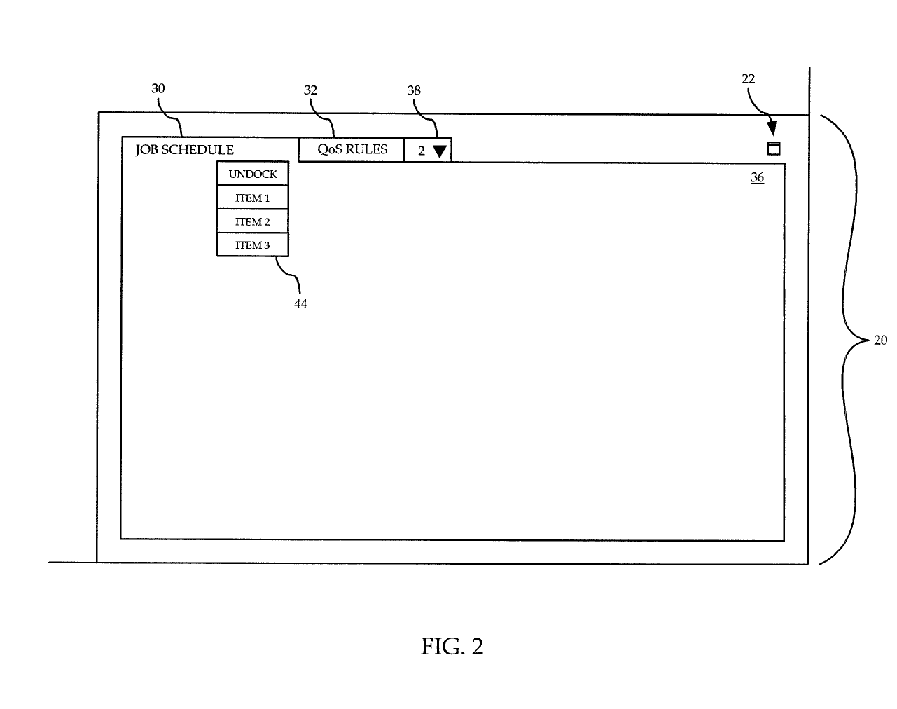

Referring to FIG. 2, a diagram of an example area 20 according to one embodiment of the invention is shown. The area may include at least one tab 30 and 32 called a “portlet tab”, and may include at least one stacked panel called a “portlet” 36. If a portlet tab is not visible due to width constraints of the area in which the portlet tab would otherwise be present, then a drop-down list 38 containing identifications of additional portlets is used. Each portlet tab and if present each item in the drop-down list has an associated portlet, and selecting one of the portlet tabs or an item in the drop-down list makes the portlet 36 associated with that portlet tab or item visible. Each portlet is a display of information, either information directly from a database or derived from information in the database. Only one portlet is displayed within each area, but if more than one portlet is available then the user can select a particular portlet to be displayed using the portlet tabs or drop-down list within the area. In the example shown in FIG. 2, the user can select between four portlets in the area, although selection of a portlet for viewing in an area does not affect which portlets are selectable or visible in other areas. The portlet tabs 30 and 32 and, if present, the drop-down list 38 merely provide the means of navigating between the portlets.

Each portlet also has a context menu 44 which may become visible, for example by right-clicking on the portlet. One of the items in the context menu 44 is UNDOCK.

Broadly, a graphic user interface is displayed. A perspective is displayed, the perspective containing at least one area. Each area may contain at least one portlet tab, each portlet tab being associated with one portlet containing certain aspects of data. A floating window is also displayed so as to overlay portions of at least one of the areas. The floating window contains at least one portlet.

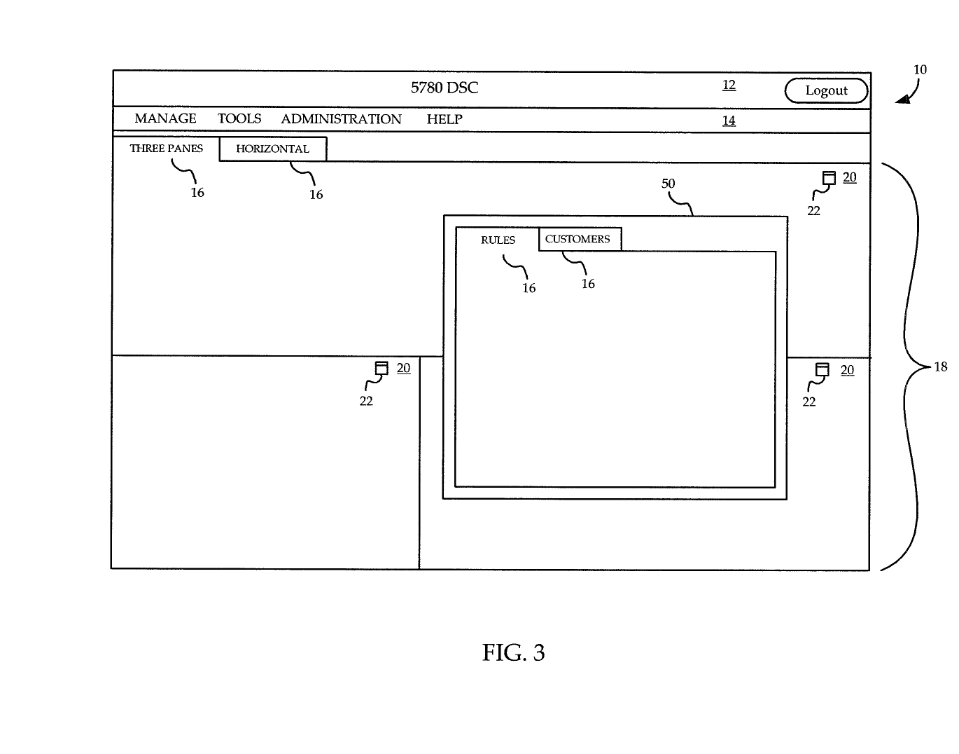

Referring to FIG. 3, a diagram of an example perspective in which a floating window has been created according to one embodiment of the invention is shown. The perspective includes a floating window 50 which is not tied to any area 20 and is displayed as overlaying a portion of or the entirety of each area, although any portions of areas not blocked by the floating window 50 are visible. The floating window 50 can be resized and can be moved freely about the perspective independently of the areas 20, both of which actions can be used to reveal important information contained in the other areas 20. The floating window 50 can contain any type of portlet, and any portlet in an area 20 can be dragged to the floating window 50 and thereafter is located within the floating window 50.

Despite not being an area 20 within the perspective, the floating window 50 is part of the perspective. If another perspective is selected for viewing, the floating window 50 is hidden along with the rest of the original perspective and the other perspective is displayed. If the original perspective is made visible again, then the floating window 50 returns to view along with the rest of the perspective.

The floating window 50 contains at least one portlet, each accessible via a portlet tab or a drop-down menu. Portlets within the floating window 50 behave the same and have the same characteristics as portlets within an area 20, including methods of selecting one of the portlets.

The floating window 50 can be created by selecting the UNDOCK item from the context menu 44 of a portlet. In such an event, the floating window 50 is in non-modal mode. The floating window 50 is created and the portlet for which the UNDOCK item was selected is placed in the floating window 50. Thereafter, other portlets can be added to the floating window 50 by dragging a portlet from the area in which it exists to the floating window 50. Any portlet, including the portlet for which the floating window was created, can also be dragged from the floating window 50 to one of the areas of the perspective, assuming of course that that area supports the presence of that type of portlet. If the last portlet within the floating window 50 is dragged to one of the areas of the perspective, then the floating window 50 is closed.

If the UNDOCK item is selected from the context menu 44 of a portlet within one of the areas 20 while the floating window 50 is present, a second floating window is created and the newly undocked portlet is moved from its area to the second floating window. This can occur any number of times, and it is possible to have many floating windows within the perspective at the same time. If there is more than one floating window, then a portlet within one floating window can be dragged to another floating window.

The floating window 50 can also be created by an application-specific request for data. An application-specific request for data may launch a floating window 50 in modal mode and create a portlet for the data in the floating window 50. The floating window 50 is in modal mode in that access to any other aspects of the application is prohibited, and a user can only interact with the floating window 50 and the portlet contained therein. Such a floating window 50 is closed by the user expressly selecting an option to close the floating window 50, such as selecting a DONE button of the floating window 50.

The two methods of creating floating windows may be implemented separately, or they may be combined. If combined, then the floating window created by an application-specific request for data may overlay a portion of or even the entirety of an existing floating window created by selection of an UNDOCK item.

The logic of the methods is preferably in the form of software, and may be stored as instructions on computer-readable storage media which can cause a computer processor to create portlets in the manner described herein. The information presented in the portlets may be information about customers in a telecommunication network, which may be obtained from a database, or may be any other sort of information.

The embodiments presented are exemplary only and persons skilled in the art would appreciate that variations to the embodiments described above may be made without departing from the spirit of the invention. For example, the various menus, title bars, and icons described above and shown in the figures are examples only, and other text and/or icons can be used. The scope of the invention is solely defined by the appended claims.

I/We claim:

1. A method of displaying a graphical user interface, comprising:
displaying one perspective;
within the perspective, displaying at least one area;
within each area, displaying at least one portlet tab, each such portlet tab being associated with one portlet;
within each area, displaying the portlet associated with a selected one of the at least one portlet tab within the area; and
displaying a floating window so as to overlay portions of at least one of the areas, the floating window containing at least one portlet and being freely movable about the perspective.

2. The method of claim 1 further comprising:
upon selection by a user, hiding the original perspective and the floating window and displaying a different perspective; and
upon selection by the user, displaying the original perspective and the floating window.

3. A method of displaying a graphical user interface, comprising:
displaying one perspective;
within the perspective, displaying at least one area;
within each area, displaying at least one portlet tab, each such portlet tab being associated with one portlet;
within each area, displaying the portlet associated with a selected one of the at least one portlet tab within the area;
displaying a context menu for a portlet which is visible, the context menu including a selectable item to undock the portlet; and
displaying a floating window so as to overlay portions of at least one of the areas upon selection of the item to undock the portlet, removing the portlet from its area, and displaying the portlet in the floating window.

4. The method of claim 3 wherein any portlet in the areas can be dragged to the floating window, wherein any portlets in the floating window can be dragged to any of the areas, and wherein the floating window is closed when the floating window contains no more portlets.

5. The method of claim 4 further comprising:
upon selection by a user, hiding the original perspective and the floating window and displaying a different perspective; and
upon selection by the user, displaying the original perspective and the floating window.

6. The method of claim 3 further comprising:
displaying a second context menu for a second portlet which is visible, the second context menu including a selectable item to undock the portlet; and
displaying a second floating window so as to overlay portions of at least one of the areas upon selection of the item to undock the second portlet, removing the second portlet from its area, and displaying the second portlet in the second floating window.

7. The method of claim 6 wherein any portlet in the areas can be dragged to either floating window, wherein any portlets in the either floating window can be dragged to any of the areas or to the other floating window, and wherein either of the floating windows is closed when that floating window contains no more portlets.

8. The method of claim 3 further comprising:
when an application-specific request for data is required, displaying a second floating window so as to overlay portions of at least one of the areas, the second floating window containing a portlet displaying the data and being freely movable about the perspective.

9. The method of claim 8 wherein a user cannot interact with the perspective when the floating window is displayed.

10. The method of claim 9 further comprising:
upon selection by the user, hiding the original perspective and the floating window and displaying a different perspective; and
upon selection by the user, displaying the original perspective and the floating window.

11. The method of claim 8 wherein the second floating window overlays a portion of the first floating window.

12. A method of displaying a graphical user interface, comprising:
displaying one perspective;
within the perspective, displaying at least one area;
within each area, displaying at least one portlet tabs, each such portlet tab being associated with one portlet;
within each area, displaying the portlet associated with a selected one of the at least one portlet tab within the area; and
when an application-specific request for data is required, displaying a floating window so as to overlay portions of at least one of the areas, the floating window containing a portlet displaying the data and being freely movable about the perspective.

13. The method of claim 8 wherein a user cannot interact with the perspective when the floating window is displayed.

14. The method of claim 9 further comprising:
upon selection by the user, hiding the original perspective and the floating window and displaying a different perspective; and
upon selection by the user, displaying the original perspective and the floating window.
